(19) United States
(12) Patent Application Publication
(10) Pub. No.: US 2009/0135850 A1
(43) Pub. Date: May 28, 2009

(54) METHOD AND APPARATUS OF TRANSMITTING RESOURCE-REQUEST FOR EFFICIENTLY USING SERVICE IDENTIFIER (SID) RESOURCE IN CABLE MODEM SYSTEM SUPPORTING UPSTREAM CHANNEL-BONDING

(76) Inventors: Seung Eun HONG, Daejeon (KR); Ho Jin KWON, Seoul (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/182,285

(22) Filed: Jul. 30, 2008

(30) Foreign Application Priority Data
Nov. 27, 2007 (KR) 10-2007-0121485

(51) Int. Cl. H04L 29/02

(52) U.S. Cl. 370/468

(57) ABSTRACT

A method and apparatus of transmitting a resource-request for efficiently using a Service Identifier (SID) resource in a Cable Modem (CM) system supporting upstream channel-bonding relates a method of transmitting an upstream packet in the CM system for performing transmission using a plurality of upstream channels.

Since a difference between a resource-request and resource-allocation when performing an additive resource-request with respect to new-generated packets before completing resource-allocation with respect to a previous resource-request transmitted by a CM causes an upstream transmission queue depth increase in the CM and delay due to the increase, a method of solving the above-described problem is provided.

A method of recalculating a bandwidth amount requested by a CM using a Cable Modem Termination System (CMTS) having received a Cumulative (bandwidth) Request (CR) and an Additive (bandwidth) Request (AR) from the CM is provided.

### CROSS-REFERENCE TO RELATED APPLICATION

This application claims priority from Korean Patent Application No. 10-2007-0121485, filed on Nov. 27, 2007, in the Korean Intellectual Property Office, the entire disclosure of which is incorporated herein by reference.

### BACKGROUND OF THE INVENTION

1. Field of the Invention

The present invention relates to resource request and allocation technology for transmitting an upstream packet in a Cable Modem (CM) system, and more particularly, to a method and apparatus of transmitting a resource-request for efficiently using a Service Identifier (SID) resource in a CM system supporting upstream channel-bonding.

This work was supported by the IT R&D program of MIC/IITA [2006-S-019-02, The Development of Digital Cable Transmission and Receive System for 1 Gbps Downstream].

2. Description of Related Art

A Cable Modem (CM) system according to Data Over Cable Service Interface Specifications (DOCSIS) 3.0 may use a channel-bonding scheme of transmitting data using a plurality of upstream transmission channels. In the case of upstream transmission in the CM system, since a plurality of CMs transmits the data to a single Cable Modem Termination System (CMTS), the CMTS appoints an opportunity for upstream transmission performed by a specific CM. For this, the plurality of CMs having data to be transmitted upstream must report an amount of data to the CMTS. The CM must classify and report the data amount for each service flow. Accordingly, the CMTS requires a method of allocating an upstream transmission resource after classifying the CM reporting the amount of data to be transmitted upstream and a service flow of the CM.

As described above, an identifier to classify the CM and the service flow is used during a resource-request and resource-allocation process for upstream transmission, and the identifier is referred to as a Service Identifier (SID). The SID is used for uniquely identifying the CM and the service flow in a specific upstream channel.

Before resource-allocation with respect to a previous resource-request transmitted by the CM is completed, an additive resource-request with respect to newly-generated packets (referred to as an outstanding resource-request) may be performed, and this is for completely filling an upstream pipe, widened using channel-bonding, with traffic. However, since additive resource-request information may be lost due to a channel-error and the CM may fail to quickly process the additive resource-request information, resource-request information and resource-allocation information may be different from each other.

Since a difference between a resource-request and resource-allocation causes an upstream transmission queue depth increase in the CM and a delay due to the increase, a method of solving the above-described problem is required.

### SUMMARY OF THE INVENTION

An aspect of the present invention provides a method of efficiently transmitting a plurality of outstanding resource-requests in order to prevent Service Identifier (SID) resource waste by allocating a single SID cluster for each Cable Modem (CM) service flow, and to sufficiently utilize an upstream band widened using channel-bonding.

Another aspect of the present invention also provides a method of detecting a MAP message loss due to a downstream channel error and the like, upstream packet drop in a CM, or a bandwidth message loss requested by the CM, or requesting a Cumulative (bandwidth) Request (CR) by the CM using either a piggyback scheme or a stand-alone scheme when a bandwidth is requested using an Additive (bandwidth) Request (AR) corresponding to a predetermined number of times in a method of requesting an upstream bandwidth for transmitting an upstream packet in a CM performing transmission using a plurality of upstream channels.

Another aspect of the present invention also provides a method of recalculating a bandwidth amount requested by a CM using a Cable Modem Termination System (CMTS) having received a CR and an AR from the CM.

According to an aspect of the present invention, there is provided a method of controlling a CM request verification device, the method including: verifying whether a new packet arrives; calculating a requested additive resource amount based on a size of the new packet for an additive upstream bandwidth request when the new packet is verified as arriving; and determining a resource request method after the calculating of the requested additive resource amount.

According to another aspect of the present invention, there is provided a method of controlling a CM cumulative request block, the method including: waiting for a cumulative bandwidth request signal input; calculating an overall size of packets to transmit in a current upstream packet buffer device when a cumulative bandwidth request signal is inputted based on a result of the waiting; verifying whether an upstream channel resource is allocated after the calculating; and transmitting an upstream packet and transmitting the calculation result to an upstream Media Access Control (MAC) frame processing device when the upstream channel resource is verified as being allocated.

According to still another aspect of the present invention, there is provided a method of processing upstream bandwidth allocation of a CMTS, the method including: verifying whether a bandwidth request message or segment headers is/are collected during a period of collecting bandwidth request information; verifying whether the bandwidth request information is an additive request when at least one piece of the bandwidth request information is verified as being collected; calculating a requested additive bandwidth amount when the bandwidth request information is verified as being an additive bandwidth request; and calculating and updating an amount of all resources awaiting allocation with respect to a corresponding service with respect to a corresponding service after the calculating of the requested additive bandwidth amount.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a Cable Modem (CM) having a plurality of transceiving channels including an upstream bandwidth request block according to an exemplary embodiment of the present invention;

FIG. 2 is a flowchart illustrating a method of controlling a CM request verification block composing an upstream bandwidth request block according to an exemplary embodiment of the present invention;

FIG. 3 is a flowchart illustrating a method of controlling a CM additive request processing block according to an exemplary embodiment of the present invention;

FIG. 4 is a flowchart illustrating a method of controlling a CM cumulative request processing block according to an exemplary embodiment of the present invention;

FIG. 5 illustrates a structure of an additive request message for an upstream bandwidth in Data Over Cable Service Interface Specifications (DOCSIS) 3.0 according to an exemplary embodiment of the present invention;

FIG. 6 illustrates a structure of a cumulative request message for an upstream bandwidth in DOCSIS 3.0 according to an exemplary embodiment of the present invention;

FIG. 7 illustrates a structure of a segment header including additive request information for an upstream bandwidth in DOCSIS 3.0 according to an exemplary embodiment of the present invention;

FIG. 8 illustrates a structure of a segment header including cumulative request information for an upstream bandwidth in DOCSIS 3.0 according to an exemplary embodiment of the present invention;

FIG. 9 is a flowchart illustrating a method of processing upstream bandwidth allocation of a Cable Modem Termination System (CMTS) according to an exemplary embodiment of the present invention; and

FIG. 10 is a flowchart illustrating a method of calculating a cumulative allocation amount according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

In a Data Over Cable Service Interface Specifications (DOCSIS) 3.0 Cable Modem (CM) system for transmitting data using a plurality of upstream channels, a Cable Modem Termination System (CMTS) and a CM use a Service Identifier (SID) group allocated for each upstream channel during a resource-request and resource-allocation process of a specific service flow, and this is referred to as an SID cluster. Table 1 illustrates a use example of the SID cluster. For example, a term “resource” used in the present specification may be a bandwidth.

TABLE 1
An example of a single SID cluster for resource-request/resource-
allocation of four upstream channel-bondings

| | US_CH_ID | | | |
|---|---|---|---|---|
| Cluster_ID | US CH1 | US CH2 | US CH3 | US CH4 |
| Cluster_0 | 13 | 101 | 264 | 1001 |

Table 1 illustrates the SID cluster allocated to a specific CM service flow that may transmit the data using four upstream channels.

In Table 1, the upstream channels used by the CM service flow for transmitting the data are US_CH1, US_CH2, US_CH3, and US_CH4, and SIDs used by each upstream channel for the resource-request and the resource-allocation are respectively 13, 101, 264, and 1001 for each channel. The CM service flow to which the SID cluster is allocated as illustrated in Table 1 may transmit the resource-request of 400 bytes via CH2 using SID=101, and the CMTS may perform the resource-allocation for each 100 bytes to CH1/CH2/CH3/CH4 respectively using SID=13, SID=101, SID=264, and SID=1001.

Before resource-allocation with respect to a previous resource-request transmitted by the CM is completed, the DOCSIS 3.0 CM system may perform an additive resource-request with respect to newly-generated packets (referred to as an outstanding resource-request), and this is for completely filling an upstream pipe, widened using channel-bonding, with traffic using channel-bonding. However, since additive resource-request information may be lost due to a channel-error and the CM may not quickly perform processing of the additive resource-request information, resource-request information and resource-allocation information may be different from each other.

A difference between the resource-request and the resource-allocation causes an upstream transmission queue depth increase in the CM and a delay due to the increase. In order to prevent this, at least one SID cluster to a maximum of eight SID clusters may be allocated to the specific CM service flow as illustrated in Table 2 in the DOCSIS 3.0 CM system, and the following four SID cluster change standards are established.

(1) A maximum request number of times per SID cluster: This denotes a maximum resource-request number (1 through 255) generated using a predetermined SID cluster. A default value equals 0, and 0 denotes that a maximum SID cluster use value is unlimited.

(2) A maximum number of outstanding bytes per SID cluster: This denotes a maximum number of bytes (1 through 4294967295) of an outstanding resource request amount from among a resource request amount of resource-request messages transmitted using a predetermined SID cluster. A default value equals 0, and 0 denotes that a maximum SID cluster use value is unlimited.

(3) A maximum number of request bytes per SID cluster: This denotes a maximum number of bytes (1 through 4294967295) of a resource request amount requested using a predetermined SID cluster. A default value equals 0, and 0 denotes that a maximum SID cluster use value is unlimited.

(4) A maximum SID cluster use time: This denotes a maximum time value (1 through 65535, a unit: milliseconds) to use a predetermined SID cluster. A default value equals 0, and 0 denotes that a maximum SID cluster use value is unlimited.

The CM to which a plurality of SID clusters is allocated must change the SID cluster when exceeding a predetermined maximum value of any one of the above-described four standards.

TABLE 2
An example of a plurality of SID clusters for resource-
request/resource-allocation of four upstream channel-bondings

| | US_CH_ID | | | |
|---|---|---|---|---|
| Cluster_ID | US CH1 | US CH2 | US CH3 | US CH4 |
| Cluster_0 | 13 | 101 | 264 | 1001 |
| Cluster_1 | 101 | 345 | 528 | 201 |
| . | . | . | . | . |
| . | . | . | . | . |
| . | . | . | . | . |
| Cluster_7 | 999 | 205 | 101 | 13 |

As illustrated in Table 2, allocating the plurality of SID clusters for each CM service flow may waste SID resources, and this may limit a number of CMs to provide a service, and a number of service flows.

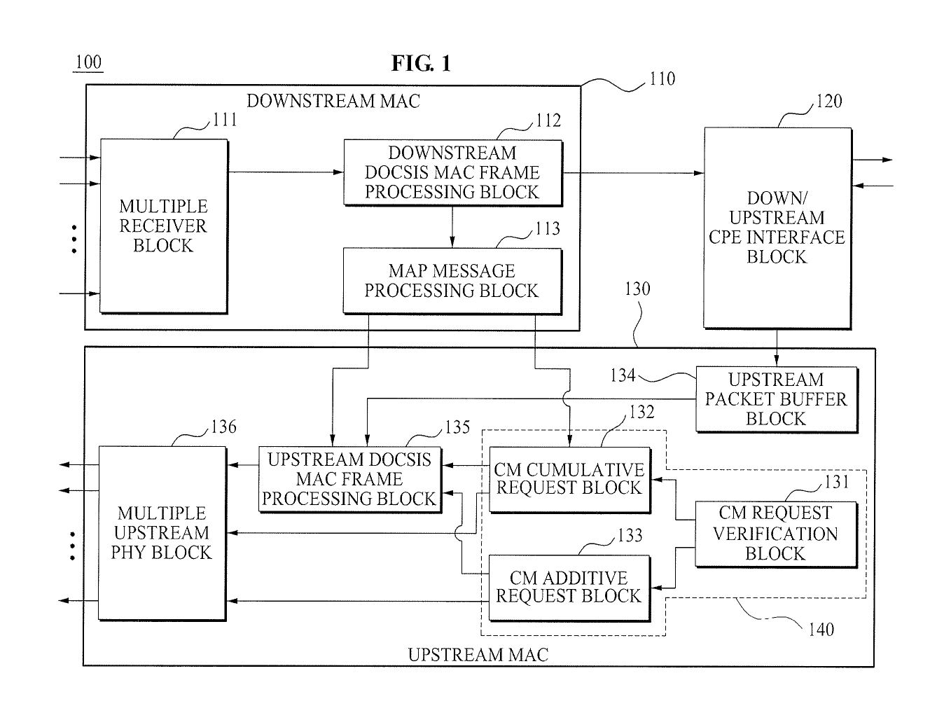

FIG. 1 is a block diagram illustrating a CM 100 having a plurality of transceiving channels including an upstream bandwidth request block according to an exemplary embodiment of the present invention.

Hereinafter, referring to FIG. 1, a configuration and operation of the CM 100 having the plurality of transceiving channels including the upstream bandwidth request block according to an exemplary embodiment of the present invention is described.

The CM 100 having the plurality of transceiving channels including the upstream bandwidth request block according to an exemplary embodiment of the present invention includes a downstream Media Access Control (MAC) 110, a down/upstream Customer Premises Equipment (CPE) interface block 120, and an upstream MAC 130. The downstream MAC 110 includes a multiple receiver block 111 to receive a Radio Frequency (RF) signal from a plurality of downstream channels and to change the RF signal into a data signal, a downstream DOCSIS MAC frame processing block 112 to receive data from the multiple receiver block 111 and to process the DOCSIS protocol, and a MAP message processing block 113 to receive a MAP message from among a MAC management message from the downstream DOCSIS MAC frame processing block 112. The down/upstream CPE interface block 120 receives downstream data from the downstream MAC 110 and transmits the downstream data to user devices, or receives the data from the user devices and transmits the data to the upstream MAC 130. The upstream MAC 130 includes an upstream packet buffer block 134 to receive upstream data from the down/upstream CPE interface block 120 and to store the upstream data, an upstream DOCSIS MAC frame processing block 135 to process an upstream packet from an upstream packet buffer, a multiple upstream physical layer (PHY) block 136 to receive the upstream data from the upstream DOCSIS MAC frame processing block 135 and to output the RF signal, and an upstream bandwidth request block 140.

In particular, the upstream bandwidth request block 140 includes a CM request verification block 131, a CM cumulative request block 132, and a CM additive request block 133. The CM request verification block 131 verifies an upstream packet buffer device, recognizes existence of a packet to transmit, subsequently determines and reports a method of requesting a resource, and verifies a MAP message processing error, thereby controlling an additive or cumulative request block. The CM cumulative request block 132 calculates an overall size of packets to transmit in a current upstream packet buffer device based on the determining and reporting of the method of requesting the resource in the CM request verification device, and determines whether the resource is requested using either an independent request message or a piggyback method. The CM additive request block 133 calculates a new requested resource amount (*size?) based on the determining and reporting of the method of requesting the resource in the CM request verification device, determines whether the resource is requested using either the independent request message or the piggyback method, and performs additive request-related processing.

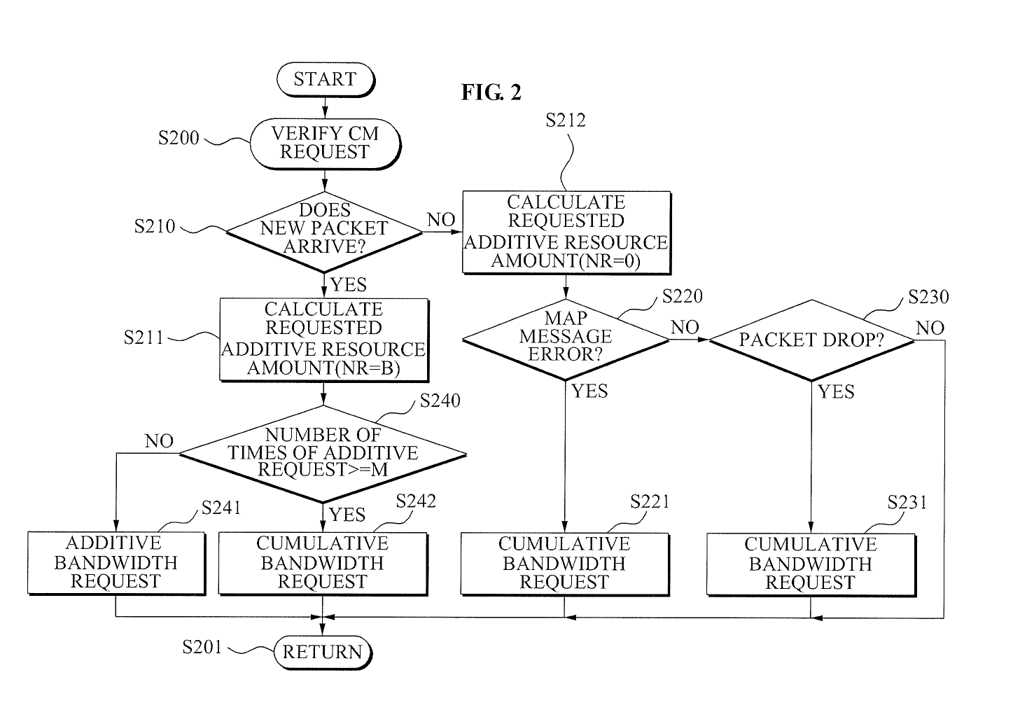

FIG. 2 is a flowchart illustrating a method of controlling a CM request verification block composing an upstream bandwidth request block according to an exemplary embodiment of the present invention.

As illustrated in FIG. 2, a CM request verification in operation S200 is for determining a method of requesting a resource after the CM request verification block recognizes existence of a packet to transmit by verifying an upstream packet buffer block.

Since there are a cumulative request method and an additive request method as the method of requesting the resource, the CM request verification block 131 determines any one of two methods. For this, in operation S210, the method verifies the upstream packet buffer block 134, and verifies a new packet, that is, whether the packet to transmit exists. In operation S211, when the new packet is verified as arriving, the method calculates a requested additive resource amount based on a size of the new packet for an additive upstream bandwidth request.

In operation S240, the method determines a resource request method after the calculating of the requested additive resource amount, and for this, the method verifies an additive request counter. In operation S241, the method outputs an additive bandwidth request signal when an additive request counter value, which indicates a number of times a CM additively requests a bandwidth, is verified as being less than a predetermined number of times. In operation S242, the method outputs a cumulative bandwidth request signal and resets the additive request counter when the additive request counter value is verified as being greater than or equal to the predetermined number of times. Accordingly, the method determines how to request the resource.

In operation S212, the method sets the requested additive resource amount as zero when the new packet is verified as not arriving based on the verifying in operation S210. In operation S220, the method verifies whether a MAP message processing error occurs in a MAP message processor. In operation S230, the method verifies whether an upstream packet is dropped when the processing error is verified as not occurring. In operation S231, the method outputs a cumulative bandwidth request when the upstream packet is verified as being dropped, and a CM cumulative request device operates.

In operation S221, the method outputs the cumulative bandwidth request when the MAP message processing error is verified as occurring.

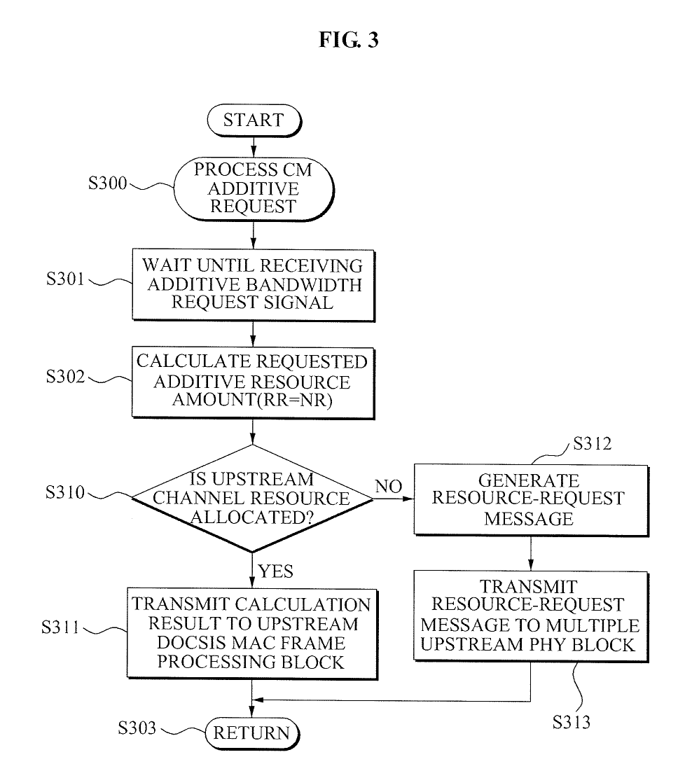

FIG. 3 is a flowchart illustrating a method of controlling a CM additive request processing block according to an exemplary embodiment of the present invention.

As illustrated in FIG. 3, when an additive request method of the above-described two methods of requesting the resource is determined, a CM additive request starts by reporting the additive request method to the CM additive request block to start a resource request.

In this case, when the CM additive request block recognizes the resource request, the CM additive request block calculates a resource request size of requiring for a new request based on an existing resource request size from among an overall size of packets to transmit in a current upstream packet buffer block, and determines whether this is requested using an independent request message, or is requested using a piggyback method.

When the resource may be allocated and an upstream packet may be transmitted, the method performs a request using the piggyback method, otherwise the method performs the request using the independent request message.

For this, a CM additive request processing in operation S300 waits until receiving an additive bandwidth request signal in operation S301. In operation S302, when the additive bandwidth request signal is received, the method calculates a new requested additive resource amount. In operation S310, the method verifies whether an upstream channel resource is allocated after the calculating of the requested additive resource amount. In operation S311, the method transmits an upstream packet, and transmits the calculation result to an upstream DOCSIS MAC frame processing device (block) to perform an additive request by a piggyback scheme when the upstream channel resource is verified as being allocated.

However, in operation S312, the method generates a resource-request message when the upstream channel resource is verified as not being allocated. In operation S313, the method transmits the generated resource-request message to a multiple upstream PHY device (block).

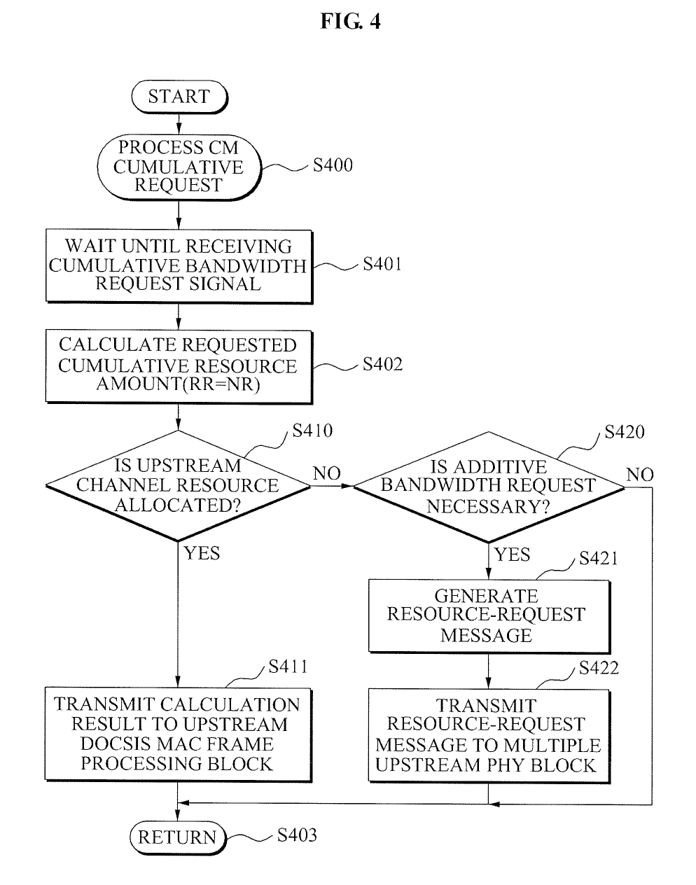

FIG. 4 is a flowchart illustrating a method of controlling a CM cumulative request processing block according to an exemplary embodiment of the present invention.

As illustrated in FIG. 4, when a cumulative request method of the above-described two methods of requesting the resource is determined, a CM cumulative request starts by requesting the resource for the CM cumulative request block.

When the CM cumulative request block recognizes the resource request, the CM cumulative request block calculates an overall size of packets to transmit in a current upstream packet buffer block, and determines whether the resource is requested using an independent request message, or is requested using a piggyback method. When the resource may be allocated and an upstream packet may be transmitted, the method performs a request using the piggyback method, otherwise the method performs the request using the independent request message.

For this, a CM cumulative request processing in operation S400 waits until receiving a cumulative bandwidth request signal in operation S401. In operation S402, when the cumulative bandwidth request signal is received, the method calculates a requested cumulative resource amount. Here, the calculating of the requested cumulative resource amount denotes calculating an overall size of all packets existing in a current upstream packet transmission buffer block. In operation S410, the method verifies whether an upstream channel resource is allocated after the calculating of the requested cumulative resource amount. In operation S411, when the upstream channel resource is allocated and the method transmits an upstream packet, the method transmits the calculation result to an upstream DOCSIS MAC frame processing device (block) to perform an additive request by a piggyback scheme.

However, in operation S420, the method verifies whether an additive bandwidth request is necessary when the upstream channel resource is verified as not being allocated. In operation S421, the method generates a resource-request message when the additive bandwidth request is verified as being necessary. In operation S422, the method transmits the generated resource-request message to a multiple upstream PHY device (block).

In particular, in order to classify a Cumulative (bandwidth) Request (CR) and an Additive (bandwidth) Request (AR) when the CM including an upstream bandwidth request block according to an exemplary embodiment of the present invention requests either the CR or the AR using the piggyback scheme and the stand-alone scheme in order to receive the upstream resource, the method sets either an upstream resource request message or a specific field value in a segment header, thereby enabling the CMTS to determine the CR and the AR. Here, the piggyback scheme denotes a flow control scheme by which a receiving side does not immediately transmit an acknowledgment with respect to the received data, attaches an acknowledgment field to an existing data frame without separately using a control frame only when the data to transmit exists, and transmits the acknowledgment field.

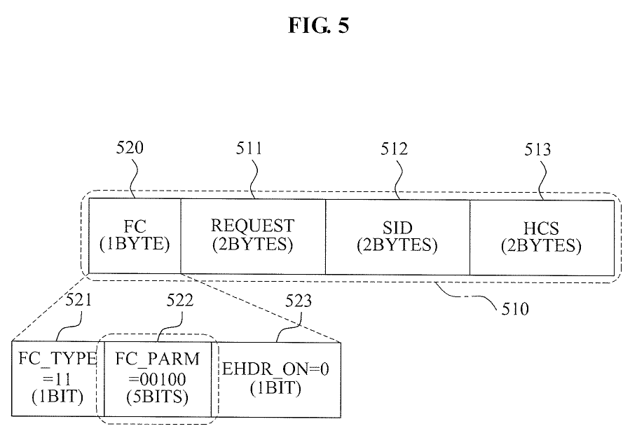

FIGS. 5 through 8 illustrate change fields and values of an upstream resource request message and a segment header for classifying the above-described CR and the above-described AR according to an exemplary embodiment of the present invention.

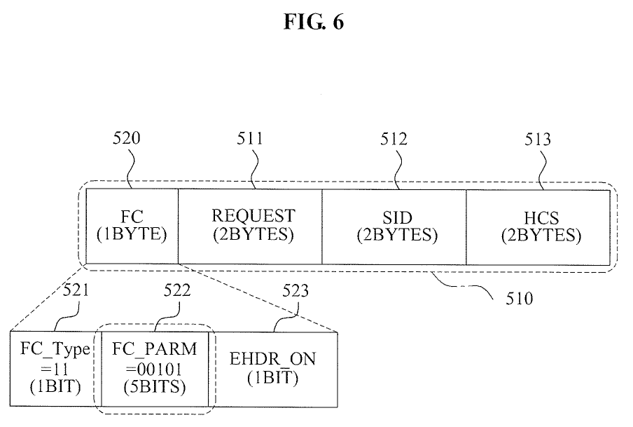

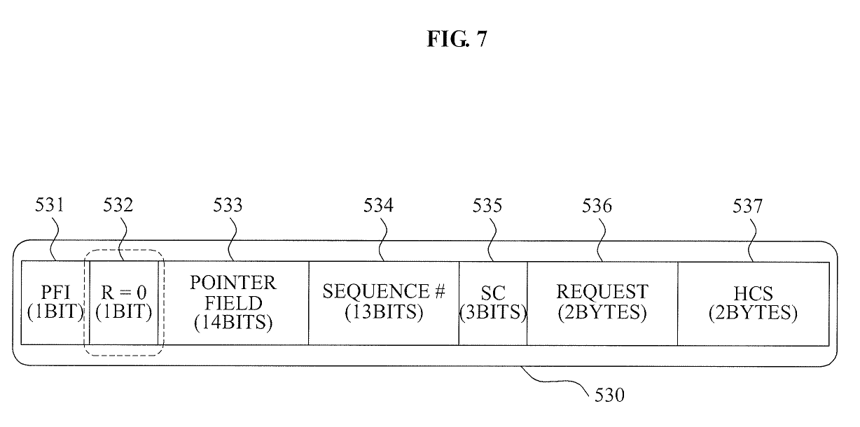

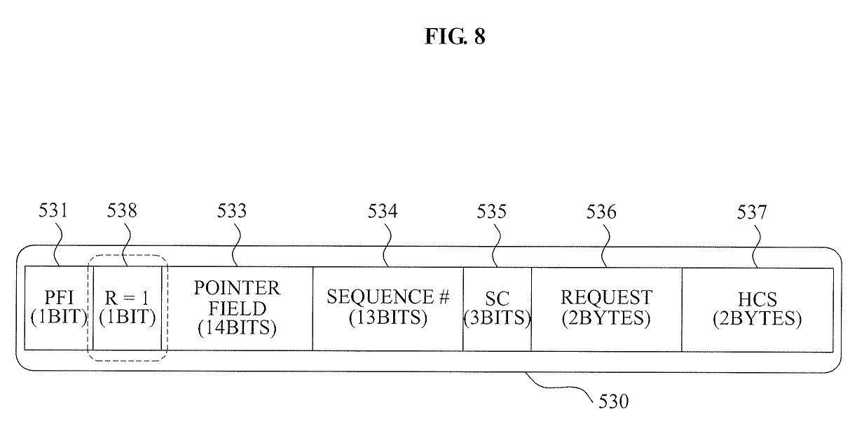

FIG. 5 illustrates a structure of an additive bandwidth request message according to an exemplary embodiment of the present invention, FIG. 6 illustrates a structure of a cumulative bandwidth request message according to an exemplary embodiment of the present invention, FIG. 7 illustrates a structure of a segment header including additive bandwidth request information according to an exemplary embodiment of the present invention, and FIG. 8 illustrates a structure of a segment header including cumulative bandwidth request information according to an exemplary embodiment of the present invention. Hereinafter, each is described.

FIG. 5 illustrates a structure of an additive request message for an upstream bandwidth 510 in DOCSIS 3.0 according to an exemplary embodiment of the present invention.

Hereinafter, referring to FIG. 5, the structure of the additive request message for the upstream bandwidth 510 in DOCSIS 3.0 according to an exemplary embodiment of the present invention is described.

As illustrated in FIG. 5, the additive request message for the upstream bandwidth 510 in DOCSIS 3.0 includes a Frame Control (FC) field 520 denoting type information of a frame and extension header information, a request field 511 denoting information about an upstream resource amount to request, an SID field 512 denoting a service to request and request information, and a Header Check Sequence (HCS) field 513 to verify a transmission error of the additive request message for the upstream bandwidth 510.

In particular, the FC field 520 includes a frame type field 521 denoting a frame type, a frame parameter field 522 denoting frame information based on the frame type, an EHDR_ON field 523 denoting whether an extension header exists, and the like. Since a frame type field value of the additive request message for the upstream bandwidth 510 is a MAC management message, the value equals b11, and since a frame parameter field value is a request message, the value equals b00100. Since an EHDR_ON field value has no extension header, the value equals b0.

FIG. 6 illustrates a structure of a cumulative request message for an upstream bandwidth 510 in DOCSIS 3.0 according to an exemplary embodiment of the present invention.

Hereinafter, referring to FIG. 6, the structure of the cumulative request message for the upstream bandwidth 510 in DOCSIS 3.0 according to an exemplary embodiment of the present invention is described.

As illustrated in FIG. 6, the additive request message for the upstream bandwidth 510 according to an exemplary embodiment of the present invention includes an FC field 520 denoting type information of a frame and extension header information, a request field 511 denoting information about an upstream resource amount to request, an SID field 512 denoting a service to request and request information, and an HCS field 513 to verify a transmission error of the cumulative request message for the upstream bandwidth 510.

In particular, the FC field 520 includes a frame type field 521 denoting a frame type, a frame parameter field 522 denoting frame information based on the frame type, and an EHDR_ON field 523 denoting whether an extension header exists. Since a frame type field value of the cumulative request for the upstream bandwidth 510 is a MAC management message, the value equals b11, and since a frame parameter field value is a request message, the value equals b00101. Since an EHDR_ON field value has no extension header, the value equals b0.

FIG. 7 illustrates a structure of a segment header 530 including additive request information for an upstream bandwidth in DOCSIS 3.0 according to an exemplary embodiment of the present invention.

Hereinafter, referring to FIG. 5, the structure of the segment header 530 including the additive request information for the upstream bandwidth in DOCSIS 3.0 is described.

As illustrated in FIG. 7, the segment header 530 including the additive request information for the upstream bandwidth in DOCSIS 3.0 includes a Payload Frame Check Sequence (FCS) Indicator (PFI) field 531 denoting whether a DOCSIS frame start is included, a reserved field 532, a pointer field 533 denoting a DOCSIS frame start location in the segment header including the DOCSIS frame start, a sequence number field 534 denoting a segment number with respect to a corresponding service flow, a Service Code (SC) field 535 denoting a service type, a request field 536 denoting information about an upstream resource amount to request with respect to the corresponding service flow, and an HCS field 537 to verify a segment header error.

FIG. 8 illustrates a structure of a segment header 530 including cumulative request information for an upstream bandwidth in DOCSIS 3.0 according to an exemplary embodiment of the present invention.

Hereinafter, referring to FIG. 8, the structure of the segment header 530 including cumulative request information for the upstream bandwidth in DOCSIS 3.0 according to an exemplary embodiment of the present invention is described.

As illustrated in FIG. 8, the segment header 530 including the cumulative request information for the upstream bandwidth in DOCSIS 3.0 according to an exemplary embodiment of the present invention includes a PFI field 531 denoting whether a DOCSIS frame start is included, a reserved field 532 denoting cumulative bandwidth request information, a pointer field 533 denoting a DOCSIS frame start location in the segment header including the DOCSIS frame start, a sequence number field 534 denoting a segment number with respect to a corresponding service flow, an SC field 535 denoting a service type, a request field 536 denoting information about an upstream resource amount to request with respect to the corresponding service flow, and an HCS field 537 to verify a segment header error.

Accordingly, a CMTS must respectively process four types of the bandwidth request information illustrated in FIGS. 5 through 8, and allocate a bandwidth to a CM.

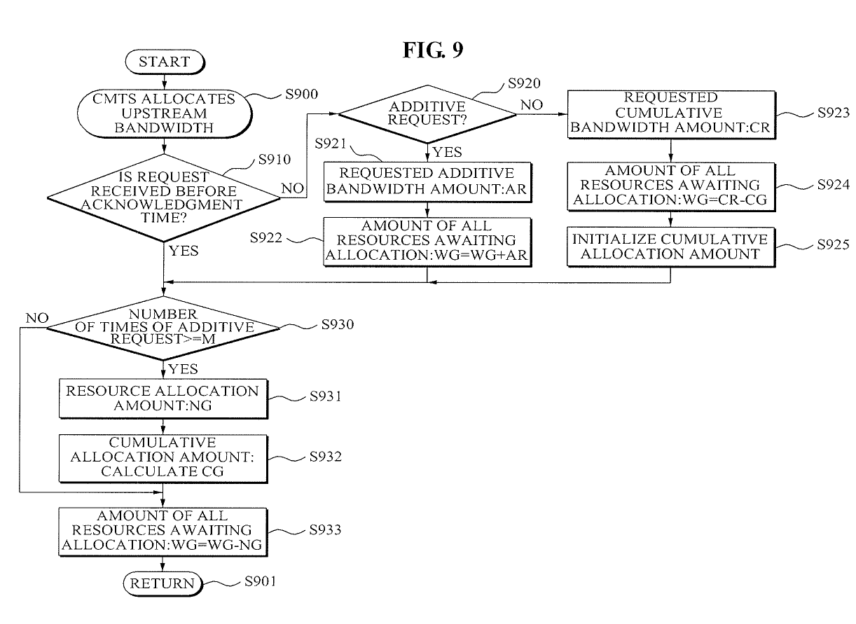

FIG. 9 is a flowchart illustrating a method of processing upstream bandwidth allocation of a CMTS according to an exemplary embodiment of the present invention.

Hereinafter, referring to FIG. 9, a method by which the CMTS according to an exemplary embodiment of the present invention processes four types of bandwidth request information and allocates a bandwidth to a CM, and a method of determining a bandwidth allocation size when allocating the bandwidth are described.

As illustrated in FIG. 9, the method of processing the upstream bandwidth allocation of the CMTS in operation S900 verifies whether a bandwidth request message or segment headers is/are collected during a period of collecting bandwidth request information in operation S910. In operation S920, the method verifies whether the collected bandwidth request information is an additive request when at least one piece of the bandwidth request information is verified as being collected. In operation S921, the method calculates a requested additive bandwidth amount when the bandwidth request information is verified as being an additive bandwidth request. In operation S922, the method calculates and updates an amount of all resources awaiting allocation with respect to a corresponding service based on the requested additive bandwidth amount.

However, in operation S923, the method calculates a requested cumulative bandwidth amount when the bandwidth request information is verified as being a cumulative bandwidth request. In operation S924, the method calculates and updates the amount of all resources awaiting allocation with respect to the corresponding service based on the calculating of the requested cumulative bandwidth amount. In operation S925, the method initializes a cumulative allocation amount.

In operation S930, the method waits until transmitting a MAP message when the bandwidth request information is not collected from the CM, or when completing the calculating of the amount of all resources awaiting allocation. In operation S931, the method allocates an upstream bandwidth when the MAP message is transmitted. In operation S932, the method updates a cumulative allocation amount. In operation S933, the method updates the amount of all resources awaiting allocation.

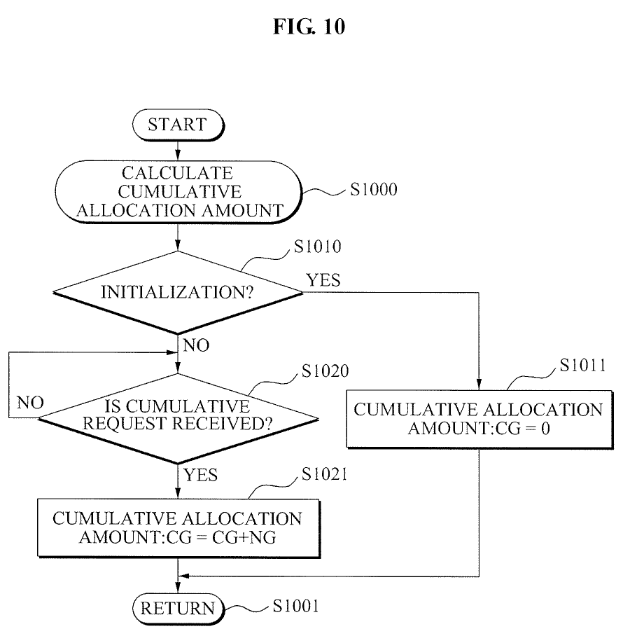

FIG. 10 is a flowchart illustrating a method of calculating a cumulative allocation amount according to an exemplary embodiment of the present invention.

In particular, FIG. 10 illustrates a process of an operation of calculating the cumulative allocation amount illustrated in FIGS. 5 through 8.

As illustrated in FIG. 10, the method of calculating the cumulative allocation amount of the CMTS in operation S1000 verifies whether an initialization process is necessary in operation S1010. In operation S1011, the method initializes the cumulative allocation amount as zero when the initialization process is verified as being necessary.

In operation S1020, the method verifies whether cumulative bandwidth request information is collected when the initialization process is verified as being unnecessary. In operation S1021, the method calculates an overall amount of a bandwidth allocated by a MAP from a time of collecting the cumulative bandwidth request information by adding a resource allocation amount and a cumulative allocation amount when the cumulative bandwidth request information is verified as being collected.

The method of transmitting the resource-request for efficiently using the SID resource in the CM system supporting the upstream channel-bonding according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, there is provided a method of efficiently transmitting a plurality of outstanding resource-requests by preventing SID resource waste using a single SID cluster for each CM service flow, and by easily restoring resource-request information that may be lost due to a channel error, thereby sufficiently utilizing an upstream band widened using channel-bonding.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of controlling a Cable Modem (CM) request verification device, the method comprising:
verifying whether a new packet arrives;
calculating a requested additive resource amount based on a size of the new packet for an additive upstream bandwidth request when the new packet is verified as arriving; and
determining a resource request method after the calculating of the requested additive resource amount.

2. The method of claim 1, wherein the determining comprises:
verifying an additive request counter;
outputting an additive bandwidth request signal when an additive request counter value, which indicates a number of times a CM additively requests a bandwidth, is verified as being less than a predetermined number of times, and outputting a cumulative bandwidth request signal and resetting the additive request counter when the additive request counter value is verified as being greater than or equal to the predetermined number of times.

3. The method of claim 1, further comprising:
setting the requested additive resource amount as zero when the new packet is verified as not arriving, and verifying whether a MAP message processing error occurs in a MAP message processor;
verifying whether an upstream packet is dropped when the processing error is verified as not occurring; and
outputting a cumulative bandwidth request when the upstream packet is verified as being dropped.

4. The method of claim 3, further comprising:
outputting the cumulative bandwidth request when the MAP message processing error is verified as occurring.

5. A method of controlling a CM cumulative request block, the method comprising:
waiting for a cumulative bandwidth request signal input;
calculating an overall size of packets to transmit in a current upstream packet buffer device when a cumulative bandwidth request signal is inputted based on a result of the waiting;
verifying whether an upstream channel resource is allocated after the calculating; and
transmitting an upstream packet and transmitting the calculation result to an upstream Media Access Control (MAC) frame processing device when the upstream channel resource is verified as being allocated.

6. The method of claim 5, further comprising:
verifying whether an additive bandwidth request is necessary when the upstream channel resource is verified as being not allocated;
generating a resource-request message when the additive bandwidth request is verified as being necessary; and
transmitting the generated resource-request message to a multiple upstream physical layer (PHY) device.

7. A method of controlling a CM additive request block, the method comprising:
waiting for an additive bandwidth request signal;
calculating a new requested additive resource amount when the additive bandwidth request signal is inputted based on a result of the waiting;
verifying whether an upstream channel resource is allocated after the calculating of the requested additive resource amount; and
transmitting an upstream packet, and transmitting the calculation result to an upstream MAC frame processing device to perform an additive request by a piggyback scheme when the upstream channel resource is verified as being allocated.

8. The method of claim 7, further comprising:
generating a resource-request message when the upstream channel resource is verified as being not allocated; and
transmitting the generated resource-request message to a multiple upstream PHY device.

9. A method of processing upstream bandwidth allocation of a Cable Modem Termination System (CMTS), the method comprising:
verifying whether a bandwidth request message or segment headers is/are collected during a period of collecting bandwidth request information;
verifying whether the bandwidth request information is an additive request when at least one piece of the bandwidth request information is verified as being collected;
calculating a requested additive bandwidth amount when the bandwidth request information is verified as being an additive bandwidth request; and
calculating and updating an amount of all resources awaiting allocation with respect to a corresponding service with respect to a corresponding service after the calculating of the requested additive bandwidth amount.

10. The method of claim 9, further comprising:
calculating a requested cumulative bandwidth amount when the bandwidth request information is verified as being a cumulative bandwidth request;
calculating and updating the amount of all resources awaiting allocation with respect to the corresponding service after the calculating of the requested cumulative bandwidth amount; and
initializing a cumulative allocation amount after the updating.

11. The method of claim 9, further comprising:
waiting until transmitting a MAP message when the bandwidth request information is not collected during the period of collecting bandwidth request information, or when completing the calculating of the amount of all resources awaiting allocation;
allocating an upstream bandwidth when the MAP message is transmitted based on the waiting result;
calculating and updating a cumulative allocation amount after the allocating of the upstream bandwidth; and
updating the amount of all resources awaiting allocation.

12. The method of claim 11, wherein the calculating of the cumulative allocation amount comprises:
verifying whether an initialization process is necessary;
verifying whether cumulative bandwidth request information is collected when the initialization process is verified as being unnecessary; and
calculating an amount of a bandwidth allocated by a MAP from a time of collecting the cumulative bandwidth request information when the cumulative bandwidth request information is verified as being collected.

13. The method of claim 12, further comprising:
initializing the cumulative allocation amount as zero when the initialization process is verified as being necessary.
